(19) United States
(12) Patent Application Publication
(10) Pub. No.: US 2008/0256863 A1
(43) Pub. Date: Oct. 23, 2008

(54) Enclosure, Especially Spa Enclosure

(76) Inventor: Jan Zitko, Chrudim (CZ)

Correspondence Address: KATTEN MUCHIN ROSENMAN LLP, 575 MADISON AVENUE, NEW YORK, NY, 10022-2585, US

(21) Appl. No.: 12/088,196

(22) PCT Filed: Oct. 3, 2006
(86) PCT No.: PCT/PL06/00065

§ 371 Date: Mar. 26, 2008

(30) Foreign Application Priority Data
Oct. 5, 2005 (PL) P-377454
Jul. 27, 2006 (PL) P-380325

(51) Int. Cl. E06B 3/34

(52) U.S. Cl. 49/41

(57) ABSTRACT

Subject of the invention is the enclosure, especially for SPA, having the shape of semispherical bowl, beneficially containing the sliding door. The enclosure, especially for SPA, according to invention, is characterized in that it contains several spherical segments (A), each of them created by frame (1), with beneficially transparent plates (2) inside, whereas the lower part of segments (A) is located on the circular or oval running track (3), placed on the ground, while on top segments (A) are separably connected to the edge of surface (B), having the shape of beneficially transparent bowl, at the same moment there is sliding door (C), between the edge of surface (B) and lower running track (3), having at least one spherical leaf.

Subject of the invention is enclosure, especially SPA enclosure, which has the shape of, beneficially rotationally sliding, semispherical cap, beneficially containing sliding door. The invention is intended especially for small pools with hydromassage, used in different atmospheric conditions.

There are known enclosures, produced from profiles, beneficially aluminum profiles, which create the frame of enclosure, inside of which there are transparent or semitransparent plates, manufactured from plastics, beneficially from polycarbonate.

There is known, from patent description U.S. Pat. No. 4,246,663, enclosure of swimming pool, containing rotationally sliding semispherical cap, whereas the cap is divided in two parts, and the smaller one, with smaller diameter is rotationally sliding into interior of bigger one. In the upper part of the enclosure, there are two coaxial, rotary bushes, located one above the other, where upper ends of rack tubes of every cap, are fixed. In the lower part, there is a system of rollers and holders, fixing the enclosure to the ground.

There is known, from Canadian patent description No CA 2154374, the enclosure for SPA or similar swimming pools, where the cover located on the extension arm, is containing the frame, ends of which have rollers moving on tracks fastened on the edge of basin.

The enclosure, especially for SPA, according to the invention, having the shape of rotationally sliding, partially divided semispherical cap, characterized in that it includes some spherical elements, each of them created by frame, having inside beneficially transparent plates, whereas the lower part of spherical segments is located on the track, having shape of circle, placed on the ground. The upper parts of segments are coupled to the edge of cover, which has the shape of beneficially transparent cap, whereas between the edge of cover and the lower track, there is slide door, consisting of at least one spherical segment. The running rail is made from the profile, the flat base of which is on one side finished with vertical wall, and on the other, vertical wall goes into horizontal blocking segment, and at the same time, in the center of base, the running rail is located, having the shape of hollow cylinder. The lower part of segment frame is created by the lower running profile, whereas the upper part is created by the lower edge profile, while the side walls of frame are made of base profile. Plates in segment are connected with centrally located intermediary base profile, while inside of lower running profile are at least two guiding rollers. The lower running profile has a bay for a plate, having shape of partly upwards open channel, below which the rectangular channel is located, and below that, the open channel, oblique to channel axis, the upper wall of which is at the same moment the lower wall of open channel, containing two longitudinal tongues. There is a door running profile fixed to side wall of running profile, having the shape of fence, finished with ball-shaped edge. The lower edge profile has a bay for plate, having shape of partly open down channel, above which the rectangular channel is located, and further above partly open polygonal channel, oblique to channel axis, whereas above this channel there is connecting shelf, containing the trapezoidal, closed channel. Base profile is containing the bay for a plate, having the shape of channel, partly open at bottom, beside which the rectangular channel is located, while on the protraction of channel wall, the shelf is located, with decreasing section, comprising the bay for sealing. Intermediary base profile is containing two symmetrically located bays, having the shape of partly down open channel, whereas in the central part, between two closed channels, the channel with rounded edges is located.

Edge of surface part is created by upper edge profile, containing oblique, partly open, rectangular channel, for the upper transparent plate, connected by side wall to partly open downwards channel, whereas the rectangular channel is connected with lower wall to partly open channel, resembling the digit 1, which is connected by lower wall with open, trapezoidal channel. The upper, transparent plate is beneficially divided into four parts, connected by intermediary profile.

The lower base of door leaf is created by running profile, to which at least one symmetrical guiding roller is fixed, at the same time, from the other side, the guiding roller is located on the running track, beneficially by arm. The upper door edge is finished with the upper running profile, beneficially containing the bay, having the shape of partly up-side open channel, below which there is a rectangular channel, at the same time inside the profile there are located at least two oblique guiding rollers, whereas the door side edges are created by base profile and plates of door leaf are beneficially connected to centrally located, intermediary base profile.

In the other alternative of invention, the enclosure of SPA is characterized in that it contains several semispherical segments, each of them created by frame, where inside are beneficially located transparent plates, at the same time the lower part of segments is located on the oval running track, placed on the ground. On the top, segments are separably connected to the edge of upper part, being beneficially transparent bowl with the oval base, comprising plates, beneficially of polycarbonate, at the same time on at least one arc part, between the edge of upper part and lower running track there are sliding door, consisting of at least one leaf, having spherical shape. The enclosure is equipped with the door, at least on one side. Upper part is created, beneficially by two semispherical bowls, beneficially transparent, with frame between them, equipped with plates and sliding part, located on tracks by guiding rollers.

The guiding track of the edge of surface is made of the profile, whose flat base is finished one side with the edge, and on the other the vertical wall is finished with horizontal, blocking segment. There is running track, located on the base, for guiding roller, having the shape of hollow cylinder, and located inside the profile. The guiding track is fixed to side wall of upper profile, connected with lower profile, while in the middle part of top cover, a track is fixed to angle surface of upper profile wall. The lower part of segments frame is created by lower running profile, whereas upper part is created by lower profile of surface edge, while frame side walls are made of base profile. Plates in segments are connected by centrally located base profile, while inside of lower running profile at least two guiding rollers are located. There is a door running profile, fixed to side wall of running profile, having the shape of strip finished with rounded edge.

The enclosure, according to invention, allows for protection of the swimming pool against, for example weather conditions, and thanks to rotary, sliding construction allows for any setting of enclosure, around the rotation axis. Whereas in the second invention alternative, construction of sliding front doors, located on arched part and side doors, as well as upper part of enclosure, allows for proper ventilation of protected space above the swimming pool. Design of enclosure allows for quick and easy assembly of particular segments and door leafs. Application of aluminum profiles and polycarbonate plates, assures high stability and durability of construction, at the comparatively low weight of enclosure.

Example of invention is presented on the drawing, where

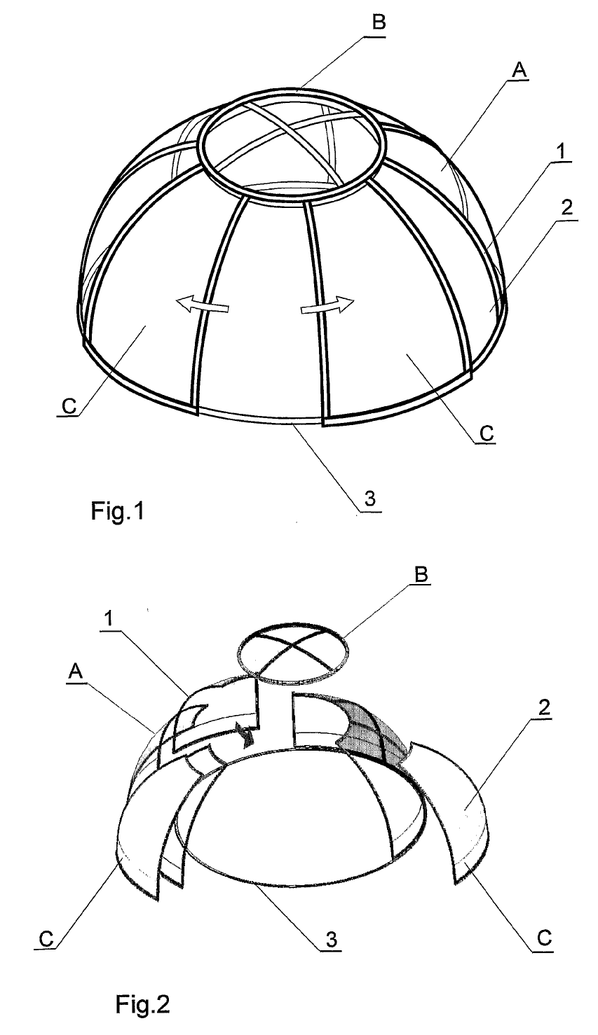

FIG. 1 shows perspective view of enclosure, from above,

FIG. 2—perspective view of partly open enclosure,

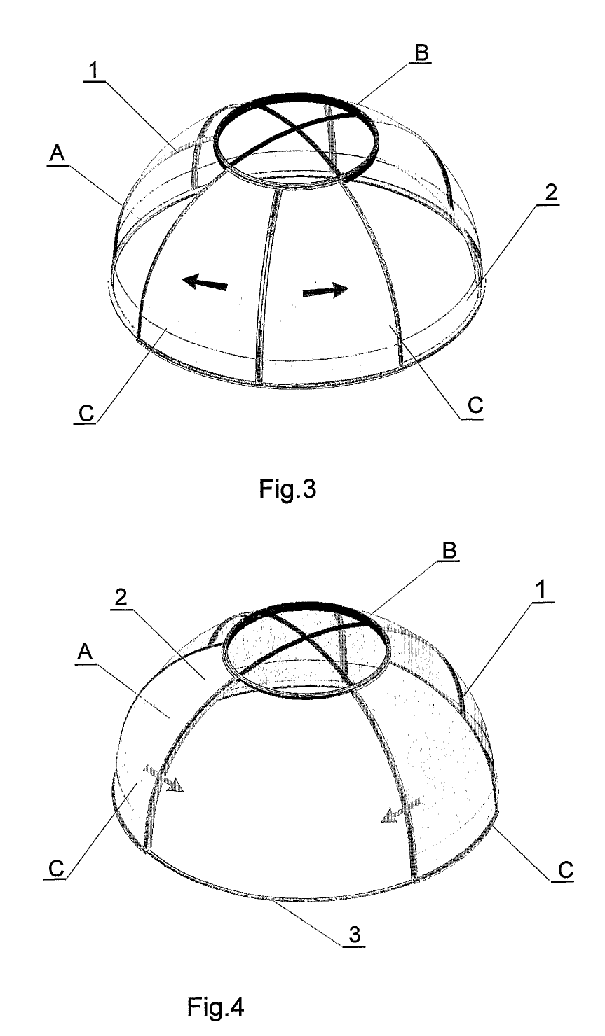

FIG. 3—perspective view of enclosure from above, with closed doors,

FIG. 4—perspective view of enclosure from above, with open doors,

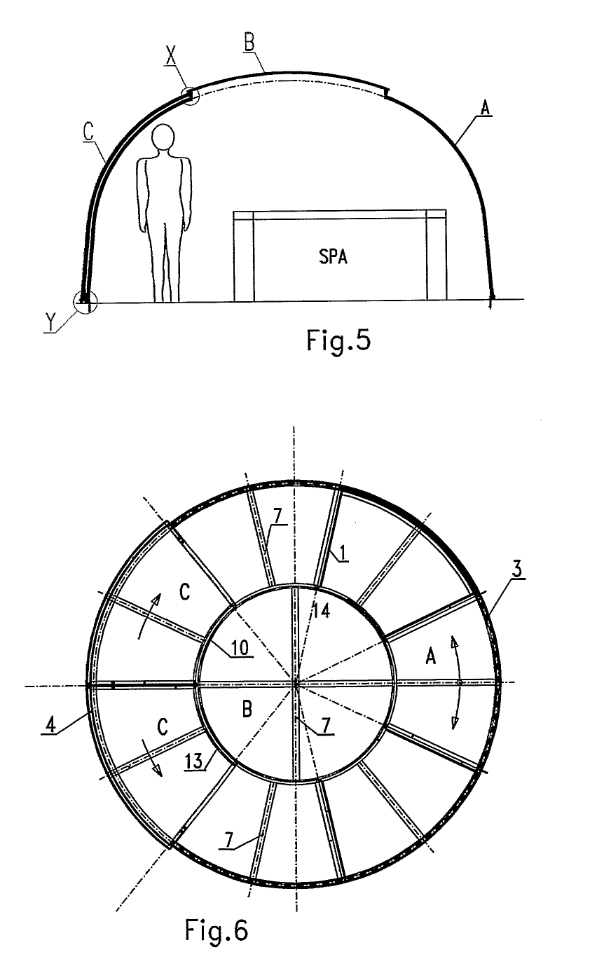

FIG. 5—cross section of enclosure,

FIG. 6—view of enclosure from above,

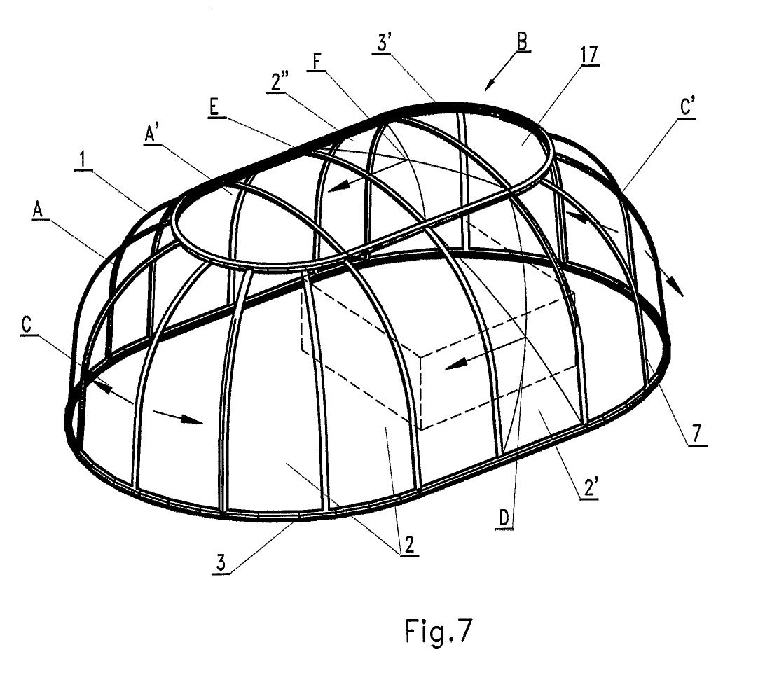

FIG. 7—perspective view of enclosure from above, for the second invention alternative,

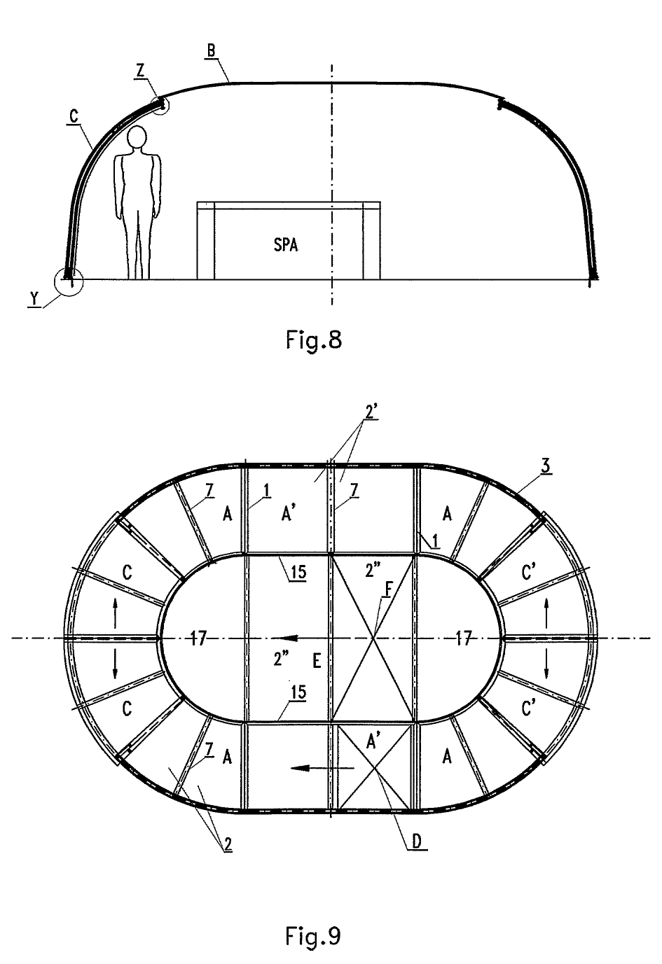

FIG. 8—cross section of enclosure for the second invention alternative,

FIG. 9—view of enclosure from above, for the second invention alternative,

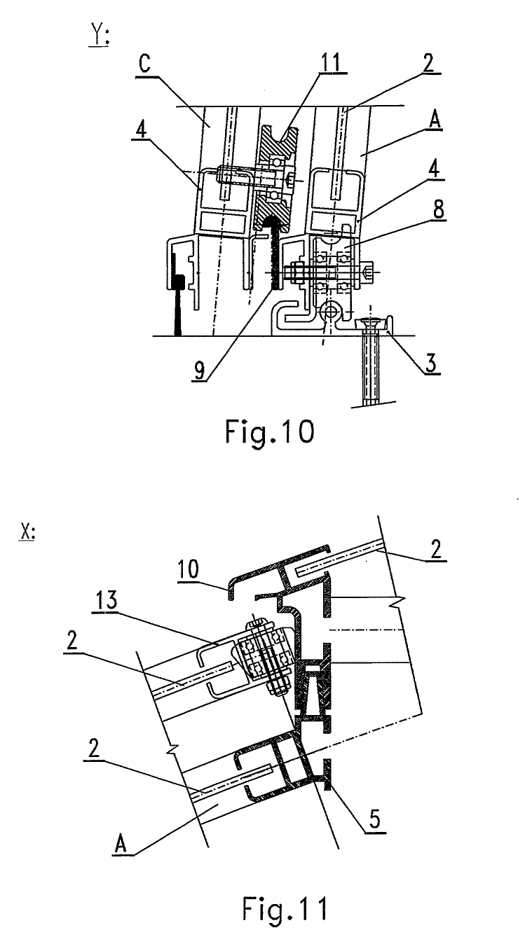

FIG. 10—section Y from FIG. 5 and FIG. 8—connection of segment A with top cover B,

FIG. 11—section X from FIG. 5 (lower connection of segment A and door leaf C),

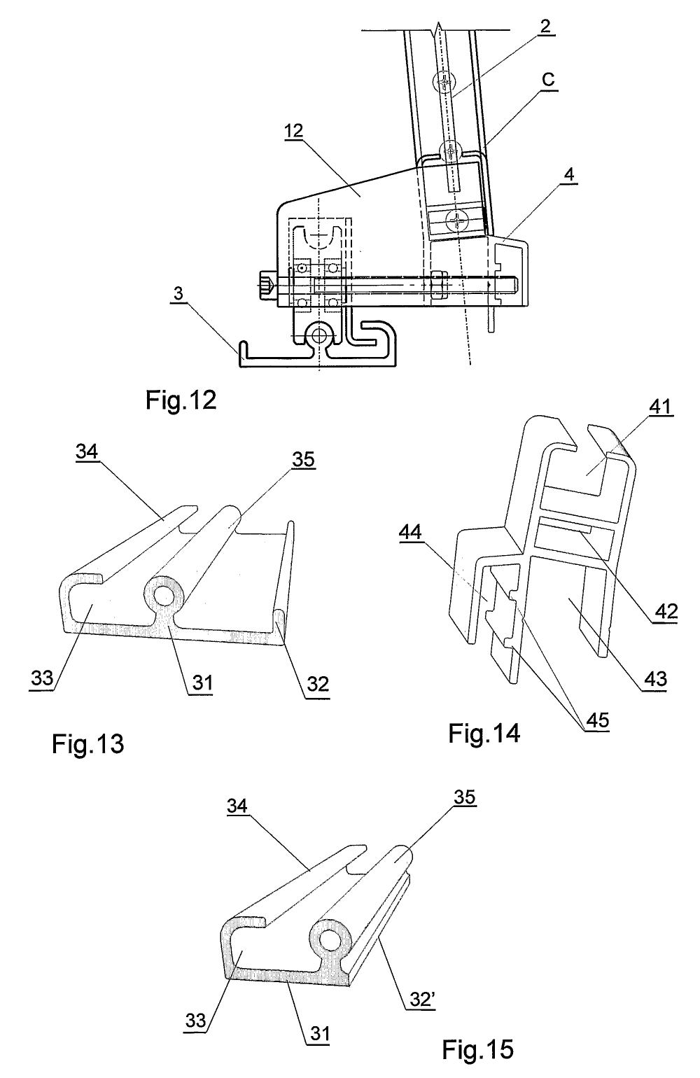

FIG. 12—front view of lower end of door leaf C,

FIG. 13—perspective view of running track profile,

FIG. 14—perspective view of lower running profile,

FIG. 15—perspective view of guiding track profile,

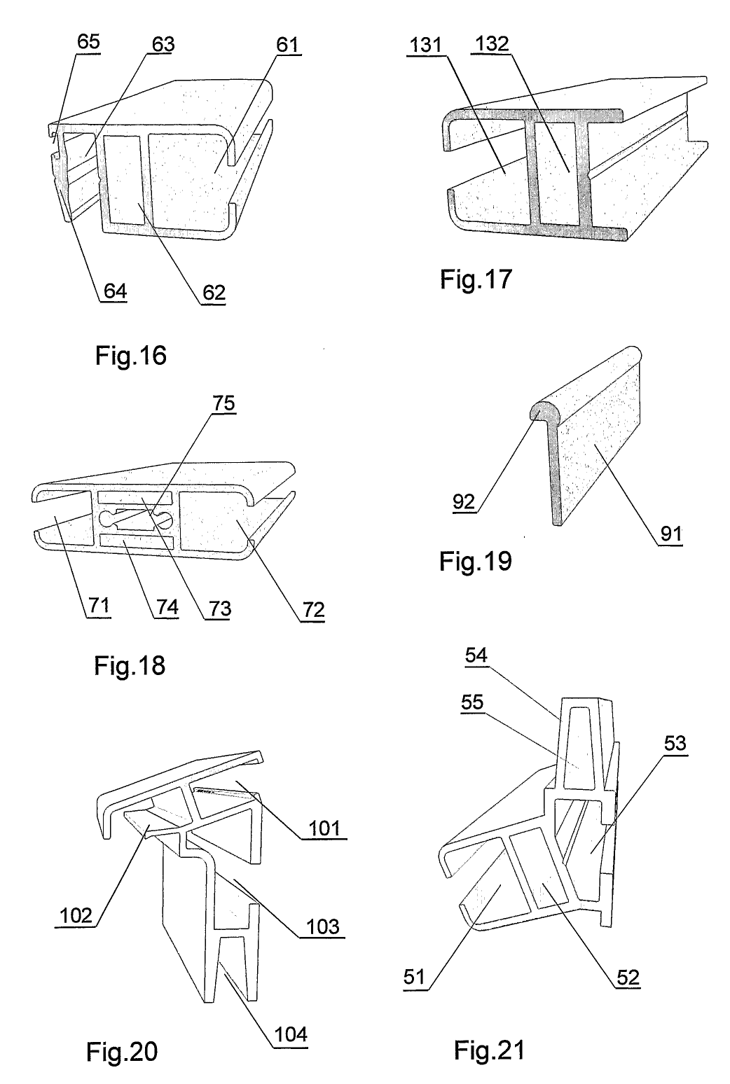

FIG. 16—perspective view of base profile,

FIG. 17—perspective view of upper running profile,

FIG. 18—perspective view of intermediary profile,

FIG. 19—perspective view of door running profile,

FIG. 20—perspective view of upper edge profile,

FIG. 21—perspective view of lower edge profile,

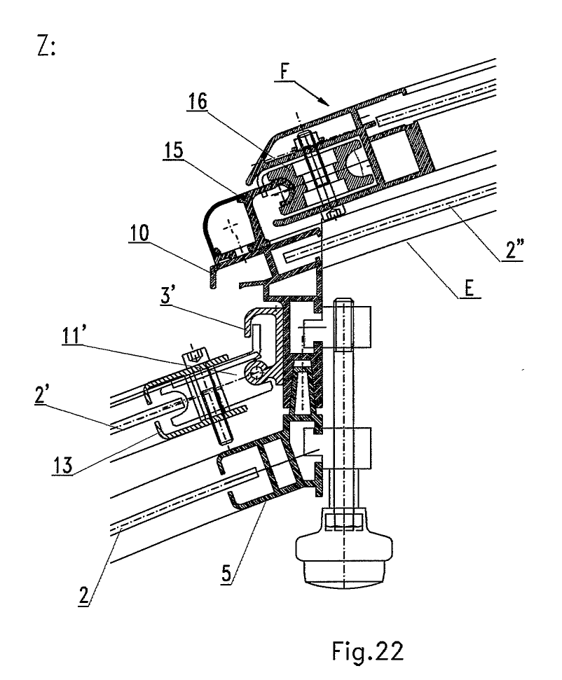

FIG. 22—section Z from FIG. 8 (connection of segment A with upper part B).

The enclosure contains several spherical segments A, each of them created from frame 1, where inside are beneficially located transparent plates 2, at the same moment the lower part of segments A is located on the circular running track 3, placed on the ground. On the top, segments A are fixed separably to the edge of top cover B, which has shape of beneficially bowl, whereas between the edge of top cover B and lower running track 3, there are sliding doors C, comprising at least one leaf, with spherical shape. The running track 3 consists of profile, the flat base 31 of which, is on one end finished with vertical wall 3, and on the other end, the vertical wall 33 is finished with horizontal, blocking segment 34, at the same time, on the base 31, the running track 35 is located, having the shape of hollow cylinder. The lower part of frame 1 of segment A creates the lower running profile 4, whereas the upper part is created by lower edge profile 5, while the side walls of frame are made from base profile 6, and plates 2 in segment A are connected with centrally located intermediary, base profile 7, and inside of lower running profile 4, at least two guiding rollers 8 are located. Running profile 4 contains the bay 41 for plate 2, having shape of partly upwards open channel, below which the rectangular, open channel 43, oblique to channel 42 axis, the upper wall of which is at the same moment the lower wall of open channel 44, containing two longitudinal tongues 45.

The door running profile 9 is fixed to the channel side wall 44 of running profile 4, having the shape of strip 91, finished with rounded edge 92. The lower edge profile 5 contains the bay 51 for plate 2, having the shape of partly open downwards channel, above which the polygonal, partly open channel 53, oblique to channel 52 axis is located, while above this channel there is the connecting shelf 54, containing trapezoidal, closed channel 55.

Base profile 6 contains the bay 61 for plate 2, having the shape of partly downwards open channel, beside which there is rectangular channel 62, while on the protrusion 63 of wall channel 62 there is the shelf 64 with decreasing cross section, containing the bay 65 for sealer. Intermediate base profile 7 contains two symmetrical bays 71 i 72, having the shape of partly downwards open channel, while in the middle part between two closed channels 73 and 74 there is the channel 75 with rounded ends.

The edge of upper part B is created by upper profile 10 containing oblique, partly open rectangular channel 101 for upper transparent plate 14, connected by lower wall with partly downwards open channel 102, whereas the rectangular channel 101 is connected with partly open channel 103, similar to digit 1, which is by lower wall connected with open, trapezoidal channel 104.

The upper transparent plate 14 is beneficially divided in four parts, connected by intermediate profile 7. The lower base of door leaf C is created by the lower running profile 4, where at least one symmetric guiding roller 11 is fixed, at the same moment the guiding roller 11 on the other side is located on running track 3, beneficially with arm 12, whereas the upper door edge is finished with upper running profile 13, beneficially containing the bay 131, having the shape of partly open upwards channel, below which there is a rectangular channel 132, while inside the profile 13 at least two oblique guiding rollers are located, and side door edges are created by base profile 6, whereas plates 2 in the door leaf C are beneficially connected with centrally located intermediate base profile 7.

In the invention alternative, the enclosure contains several spherical segments A i A′, each of them created by frame 1, with beneficially transparent plates 2 and 2′ inside, while the lower part of segments A and A′ is located on the oval running track 3, placed on the ground. Segments A and A′ are separably connected on top to the edge of upper part B, having shape of beneficially transparent oval bowl, containing plates 2″, while there is a slide door C and/or C′, having at least one spherical leaf, at least one arched segment, between edge of top cover B and lower running track 3. The enclosure is equipped with side door D. The top cover B consists of two semispherical ends 12, and frame E with slide part F between them, equipped with plates 2″, located on tracks 14 by guiding rollers 15.

Guiding track 3′ of the edge of upper part B consists of profile, the flat base 31 of which is one side finished with the edge 32′, and on the other the vertical wall 33 is finished with horizontal, blocking segment 34, while on the base 31 the running track 35 is located, having the shape of hollow cylinder for guiding roller 11′, being inside the profile 13. The guiding track 3′ is fixed to side wall of upper profile 10 connected with lower profile 5, while in the middle part of upper part B edge, the track 14 is fixed to angle surface of upper profile 10 wall.

The lower part of frame 1 of segments A and A′ is created by lower running profile 4, whereas the upper part consists of lower edge profile 5, while the frame side walls are made of base profile 6, and plates 2 i 2′ in segments A and A′ are connected with centrally located intermediary base profile 7, at the same moment at least two guiding rollers 8 are located inside of lower running profile 4. To the side wall of running profile 4, the door running profile 9 is fixed, having the shape of the strip with rounded edge.

1-15. (canceled)

16. An enclosure comprising:
a top cover having a generally concave shape;
a plurality of spherical segments each including a frame and a transparent plate formed on an inside surface of the frame, wherein a lower part of the spherical segments is located on a track placed on the ground, and a top part of the segments is separably fixed to an edge of top cover; and
at least one spherical leaf located between, and in sliding engagement with, an edge of the top cover and the track on the ground.

17. The enclosure of claim 16, wherein the track comprises:
a flat base with a vertical wall formed on a first edge of the flat base and a vertical wall with a horizontal blocking segment formed on a second edge and a hollow cylinder formed along a central portion of the track.

18. The enclosure of claim 16 having a generally round shape and comprising a round track and a bowl shaped upper part.

19. The enclosure of claim 16 having a generally oval bowl shape and comprising:
an oval track, and
the top cover is formed in a generally oval shape, said top cover including at least one arc segment between top edges of the spherical segments.

20. The enclosure, according to claim 19, characterized in that it is equipped with at least on one side with the door.

21. The enclosure, according to claim 19, wherein the top cover comprises two semispherical parts connected via frame to the at least one arc segment.

22. The enclosure according to claim 21 wherein the top cover further comprises a sliding part including guide rollers enabling the longitudinal length of the oval shaped enclosure to be reduced.

23. The enclosure according to claim 19 further comprising a guide track formed on an edge of the top cover, said guide track having a flat base with vertical wall and horizontal blocking segment from on one edge of the base and a running track for guide roller having the shape of hollow cylinder for receiving a guide roller,
wherein the guide track is fixed to a side wall of an upper profile connected to a lower profile, and wherein a the middle part of the edge upper portion a second track is fixed to an angle wall of the upper profile.

24. The enclosure of claim 16 wherein a lower part of the frames of plurality of segments comprises a lower running profile, and an upper part is created by lower edge of the profile of top cover, while the side frames are made of base profile, whereas the plates in the segments are connected to a centrally located intermediate base profile, and inside the lower running profile at least two guiding rollers are located.

25. The enclosure, according to claim 24, wherein the running profile contains a bay for the plate, said bay having the shape of a partly open upwards channel, below which there is a rectangular channel, with a first open channel below and oblique to the axis of the rectangular channel, a wall of said first open channel is also a wall of a second open channel containing two longitudinal tongues.

26. The enclosure, according to claim 25, wherein a door running profile is fixed in a channel of the running profile, the door running profile formed of a strip with the rounded edge.

27. The enclosure, according to claim 19, wherein the lower profile has the bay for the plate with a partly open downward channel, above which a rectangular channel is located, with partly open, trapezoidal channel above and oblique to the axis of the rectangular channel, while above this channel is located a connecting shelf containing a closed trapezoidal channel.

28. The enclosure, according to claim 19, wherein the base profile has a bay for the plate, having the shape of partly open downwards channel, beside which a rectangular channel is located, while on a protrusion of a channel wall a shelf with decreasing section, containing a seal is located.

29. The enclosure, according to claim 19, wherein an base profile contains two symmetrically located bays, having the shape of partly open downwards channel, while in a middle part, between two closed channels is located a channel with rounded edges.

30. The enclosure, according to claim 16, characterized in that the edge of the top cover defines an edge of an upper profile, containing an oblique, partly open rectangular channel for receiving an upper transparent plate, and connected to side wall with a partly open downwards channel, while with a lower wall a rectangular channel is connected with partly open channel, which is also connected via a lower wall with an open, trapezoidal connecting channel.

31. The enclosure, according to claim 30, wherein the upper, transparent plate is beneficially divided in four parts, connected with an intermediary profile.

32. The enclosure, according to claim 16 wherein a the lower base of a door leaf creates the lower running profile, to which at least one symmetric guiding roller is fixed, and on the other side a guiding roller is located on a running track with an arm, and wherein the upper door edge is finished with an upper running profile containing a bay having the shape of partly open upwards channel, below which a rectangular channel is located, while inside the channel at least two oblique guiding rollers are located and door side edges are created by a base profile, and plates in the door leaf are connected, with centrally located, intermediate base profiles.
